(19) United States
(12) Patent Application Publication
(10) Pub. No.: US 2018/0012174 A1
(43) Pub. Date: Jan. 11, 2018

(54) System and Method for Managing Merchant-Performed Shipment Preparation Operations at a Vendor Facility

(71) Applicants: Neeraj Srivastava, Seattle, WA (US); Michael Roth, Seattle, WA (US); Alexandre Krilov, Redmond, WA (US); Laure-Marie Coutinho, Luxembourg (LU)

(72) Inventors: Neeraj Srivastava, Seattle, WA (US); Michael Roth, Seattle, WA (US); Alexandre Krilov, Redmond, WA (US); Laure-Marie Coutinho, Luxembourg (LU)

(21) Appl. No.: 13/170,039

(22) Filed: Jun. 27, 2011

Related U.S. Application Data
(60) Provisional application No. 61/408,489, filed on Oct. 29, 2010.

(51) Int. Cl. G06Q 10/08

(52) U.S. Cl. CPC G06Q 10/087; G06Q 10/08

(57) ABSTRACT

Embodiments may include, at a vendor's materials handling facility that includes a first process management component controlled by the vendor for preparing shipments and a second process management component controlled by a merchant that receives inventory items from the vendor at the vendor's materials handling facility, utilizing the second process management component to receive order information specifying one or more items that a customer ordered from the merchant. The reserved portion of the vendor's materials handling facility may be reserved for shipment preparation operations controlled by the merchant. Embodiments may include, subsequent to the merchant receiving the item(s) from the vendor into a reserved portion of the facility reserved for merchant operations, utilizing the second process management component to control the preparation of a shipment including the one or more items specified by the order information. That shipment preparation process may be performed within the reserved portion of the facility.

### PRIORITY INFORMATION

This application claims benefit of priority to U.S. Provisional Patent Application No. 61/408,489 filed Oct. 29, 2010 titled “System And Method For Managing Merchant-Performed Shipment Preparation Operations At A Vendor Facility,” which is hereby incorporated by reference herein in its entirety.

### BACKGROUND

Online commerce has become a convenient and accessible alternative to shopping at brick and mortar retail locations. For instance, customers may visit a merchant's website to browse an electronic catalog of items through a web browser. The merchant's website may include a virtual shopping cart in which a customer may place items they desire to purchase. Customers can complete a checkout process offered by the merchant's website in order to purchase the items in the virtual shopping cart. The merchant may operate a network of one or more facilities (e.g., order fulfillment centers) at which items of the customer's order are prepared for shipping. The merchant may provide a prepared shipment that includes purchased items to a shipment carrier. The shipment carrier may operate a shipping network capable of delivering shipments to customer-specified locations, such as a residential address. In many cases, the merchant's order volume may change over time, either due to seasonal variations or longer-term trends in customer ordering activity. To alleviate stress on the merchant's network of facilities, the merchant may expand existing facilities and/or create new facilities to be added to the merchant's network; the process can be relatively time consuming and/or capital intensive.

### BRIEF DESCRIPTION OF THE DRAWINGS

FIG. 1 illustrates a block diagram of an example configuration of a materials handling facility network utilized to ship packages of ordered items to customers, according to some embodiments.

FIG. 2 illustrates a block diagram of the operations performed at a merchant materials handling facility, according to some embodiments.

FIG. 3A illustrates a block diagram of the operations performed at a vendor materials handling facility, according to some embodiments.

FIG. 3B illustrates a second block diagram of the operations performed at a vendor materials handling facility, according to some embodiments.

FIG. 4A illustrated a block diagram of the systems utilized by the merchant to receive orders and dispatch orders to respective materials handling facilities, according to some embodiments.

FIG. 4B illustrated a block diagram of the systems utilized by the merchant to receive orders and dispatch orders to respective materials handling facilities, according to some embodiments.

FIG. 5A illustrates a flowchart of an example method for assigning a shipment to a particular materials handling facility within a fulfillment network.

FIG. 5B illustrates a flowchart of an example method for managing merchant-performed shipment preparation operations at a vendor facility.

FIG. 6 illustrates one example of a computer system suitable for implementing various elements of the system and method for managing merchant-performed shipment preparation operations at a vendor facility, according to some embodiments.

While the system and method for managing merchant-performed shipment preparation operations at a vendor facility is described herein by way of example for several embodiments and illustrative drawings, those skilled in the art will recognize that the system and method for managing merchant-performed shipment preparation operations at a vendor facility is not limited to the embodiments or drawings described. It should be understood, that the drawings and detailed description thereto are not intended to limit the system and method for managing merchant-performed shipment preparation operations at a vendor facility to the particular form disclosed, but on the contrary, the intention is to cover all modifications, equivalents and alternatives falling within the spirit and scope of the system and method for managing merchant-performed shipment preparation operations at a vendor facility as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF EMBODIMENTS

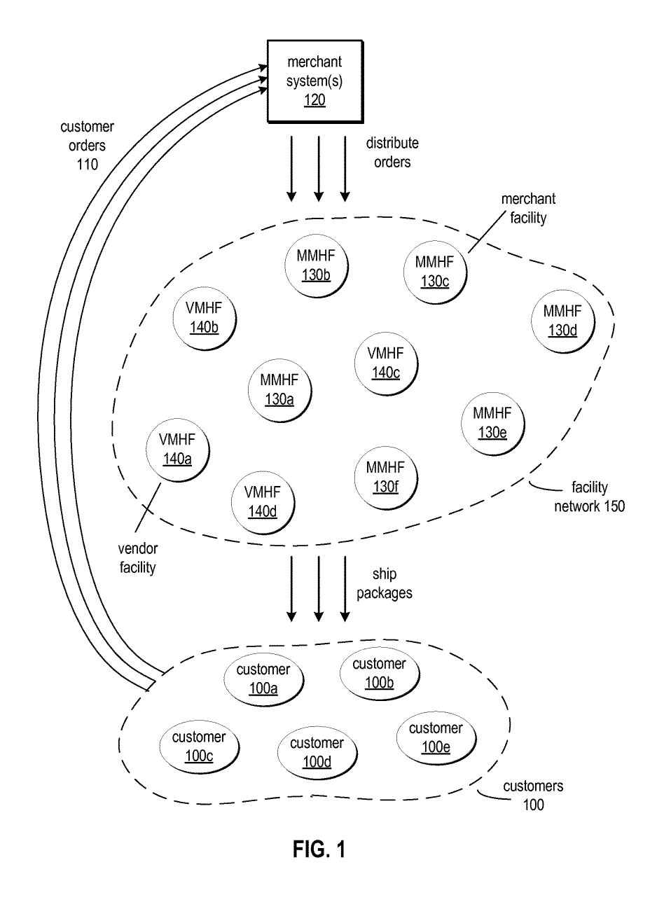

Various embodiments of a system and method for managing merchant-performed shipment preparation operations at a vendor facility are described. Embodiments described herein may reference a variety of entities, which may include but are not limited to customers, vendors, and merchants. FIG. 1 illustrates an example block diagram of the interactions between such entities within the context of various embodiments.

As illustrated in FIG. 1, one or more customers 100a-c (collectively referred to as customers 100) may submit orders 110 to one or more merchants system 120 of a merchant. For instance, a customer may browse the merchant's network-accessible product catalog and select one or more items for purchase. An order may be submitted that specifies the items the customer has selected and/or any relevant payment information. The merchant may utilize one or more merchants system(s) 120 to distribute the orders to nodes of facility network 150. In various embodiments, orders may be logically divided into smaller elements, such as multiple shipments, for fulfillment purposes. For instance, different facilities within facility network 150 may have different inventory and/or different capabilities for processing certain items.

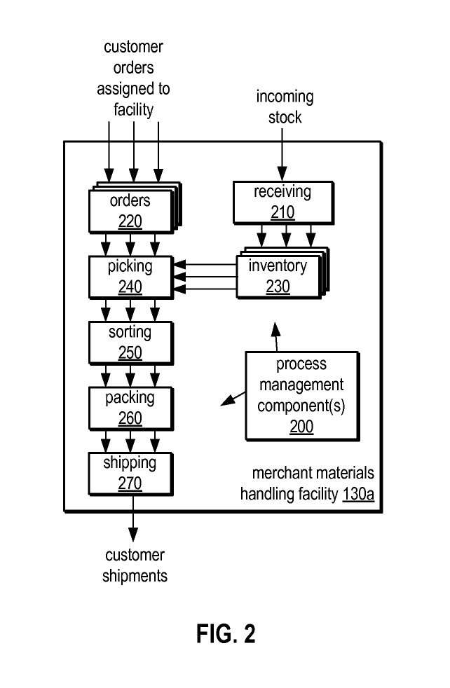

As illustrated, facility network 150 may include multiple merchant materials handling facilities for processing orders into prepared shipments that can be shipped to respective ones of customers 100 (e.g., via shipment carrier). These merchant materials handling facilities are illustrated in FIG. 1 as merchant materials handling facilities (MMHFs) 130a-130f (which may be collectively referred to as merchant materials handling facilities 130). One example of a merchant materials handling facility is described below with respect to FIG. 2, although merchant facilities of other configurations are possible and contemplated within various embodiments.

Unlike conventional views of a merchant's facility network, facility network 150 may also include multiple vendor materials handling facilities, such as vendor materials handling facilities (VMHFs) 140a-140d (which may be collectively referred to as vendor materials handling facilities 140).

While the vendor facilities may be largely under the direction and control of their respective vendor entities (which may in some embodiments be a third party), these facilities may be considered as part of the merchant's view of facility network 150 due the manner in which such facilities are configured. In a general sense, a vendor's material handling facility that adheres to this configuration may have a reserved portion (e.g., a dedicated portion of floor space, shelf space, equipment, or other areas) of the facility dedicated to merchant operations. For example, for a given vendor materials handling facility 140, that facility may include a reserved portion that includes floor space dedicated to the merchant for the purposes of shipment preparation or order fulfillment activities.

Agreements to utilize a dedicated portion of a vendor's materials handling facility may be informal or formal (e.g., established through written contracts or other legal agreements). In some cases, a merchant's use of a dedicated portion of a vendor's facility may be exclusive to that merchant, meaning no other merchant may form an agreement with the vendor to utilize a reserved portion of the respective facility.

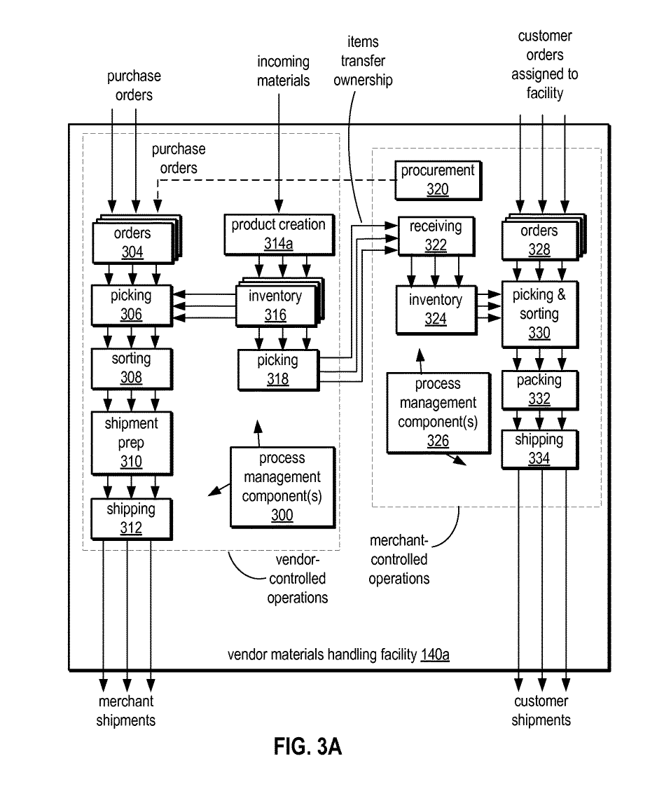

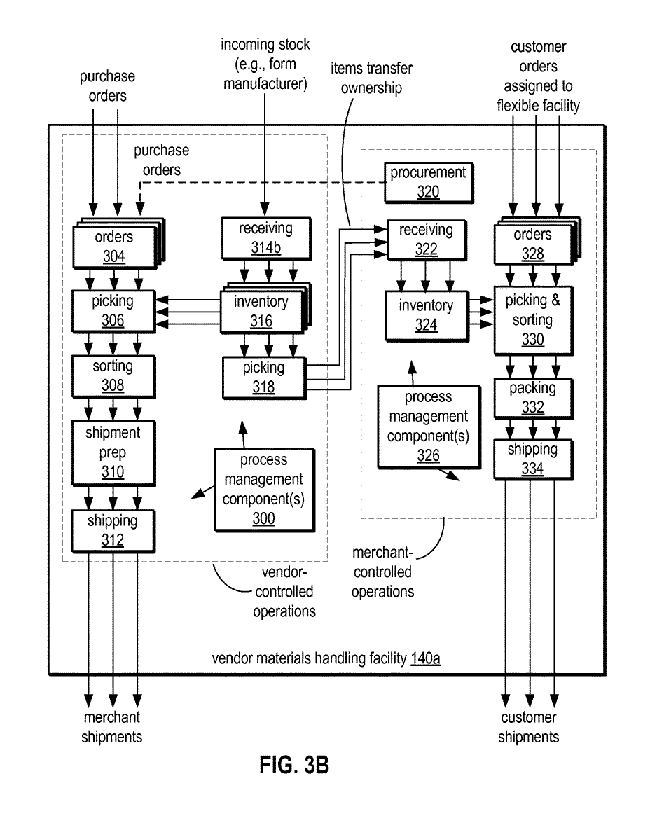

In various embodiments, for a given vendor materials handling facility, the merchant may configure the reserved portion of the facility to suit the merchant's shipment preparation needs. This may include configuring the reserved portion of the facility to handle shipment preparation to prepare shipments directly at the vendor's facility thereby avoiding the need to ship certain inventory items from the vendor facility to a merchant materials handling facility for shipment preparation. Examples of vendor materials handling facilities configured in this manner are described below with respect to FIGS. 3A-3B. As described in more detail below, FIG. 3A illustrates a vendor materials handling facility configured as a manufacture facility (e.g., a facility in which items are actually created or assembled) whereas FIG. 3B illustrates a distribution hub or downstream facility (e.g., a facility in which items are handled but not actually created or assembled. Embodiments are not limited to these types of facilities. For instance, a vendor facility in some embodiments may include some items that are created and handled whereas some other items in the facility are handled at that facility but created elsewhere.

Utilizing the configurations described herein to ship merchant shipments directly from a vendor's facility may prove to be worthwhile from the perspective of the merchant, the participating vendor, as well as the end customers of the merchant. For instance, the time required for the merchant to acquire and take ownership of items directly at a vendor facility may be much less than the time to receive the items at a remote merchant facility. In addition to improving lead times for acquiring items from vendors, utilizing the techniques described herein may reduce or eliminate shipping costs associated with the transfer of items from a vendor facility to a merchant facility. For instance, in the reserved portion of a vendor's facility, the merchant may prepare customer shipments that include items sourced from the vendor (at that vendor facility) and convey such shipment to a shipment carrier at the vendor facility. From that point, the shipment carrier may deliver the shipments to respective customers. This process may circumvent the freight shipping costs (e.g., truck load or less-than-truck load shipments) commonly associated with conveying items from the vendor facility to a merchant facility.

The embodiments described herein also provide for faster setup and shutdown times associated with opening a new facility. For instance, instead of adding another merchant-operated materials handling facility to the merchant's network (which may be time and capital intensive due to construction costs), the merchant may instead deploy a lighter-weight fulfillment configuration in the reserved portion of an existing vendor materials handling facility. In various embodiments, these lighter-weight configurations may include various elements for managing the preparation of shipments (e.g., personnel, computer systems, printers, software, etc.) without the need for more capital intensive configuration of the vendor's traditional materials handling facilities. For instance, relative to an existing merchant facility of the merchant's network, the reserved area of a vendor facility may in some cases include smaller quantities of merchant personnel, less equipment (e.g., no large sortation systems, such as Crisplant sorters), and less inventory. Of course, the exact configuration of the reserved area of a vendor's facility may vary according to different embodiments. Comparisons to the merchant's existing facilities are general in nature.

The embodiments described herein also expand the merchant's inventory capacity and order throughput without the need to build additional merchant materials handling facilities. For instance, in addition to the inventory the merchant may hold at merchant materials handling facilities 130, the merchant may now hold (e.g., own) inventory located at any of vendor materials handling facilities 140. Furthermore, the techniques described herein may also enable the merchant to guarantee availability of certain items made available to customers. For instance, instead of relying on vendor-provided promises to deliver inventory items to the merchant, the merchant may directly take delivery of inventory items in the reserved portion of the vendor facility. Once the merchant takes delivery of such items, the merchant can be confident in making guarantees as to the availability of such items.

In various embodiments, configuring a reserved portion of a vendor's facility for merchant operations may require minimal or few resources from the vendor. For instance, due to seasonal fluctuations in demand, a vendor's facility utilization (in terms of items on hand) may inversely correlate to that of merchants. For instance, vendors may deplete their own inventory of items when trying to meet seasonal purchase orders placed by merchants. As the vendor's ship items off to fulfill purchase orders, their available inventory capacity (e.g., available free space) increases while merchant's are actively taking on more inventory to meet seasonal demand. By reserving a portion of the vendor's free space in the vendor's facility, the merchant may utilize the vendor facilities excess storage capacity to meet shipment preparation needs. In various embodiments, this process may alleviate stress on the merchant's existing facilities while diminishing any inconvenience to the vendor.

As illustrated in subsequent Figures, the components utilized at the vendor facility to manage the vendor operations and the merchant operations may be isolated from one another. That is, while the vendor enables the merchant to utilize a reserved area of the vendor's facility, the vendor does not gain knowledge as to the inner workings of the merchant's system. For instance, while the vendor may view the merchant preparing items for shipment, the vendor may not have access to the logic behind the components that control the merchant's shipment preparation process. In some cases, extra precautions may be taken to isolate the merchant's operations in the reserved area of the vendor's facility, such as visually isolating the reserved area from the rest of the vendor's facility (e.g., installing privacy curtains, etc.). In other cases, the merchant may not choose to employ such techniques as an effort to maintain goodwill and a sense of partnership with the vendor.

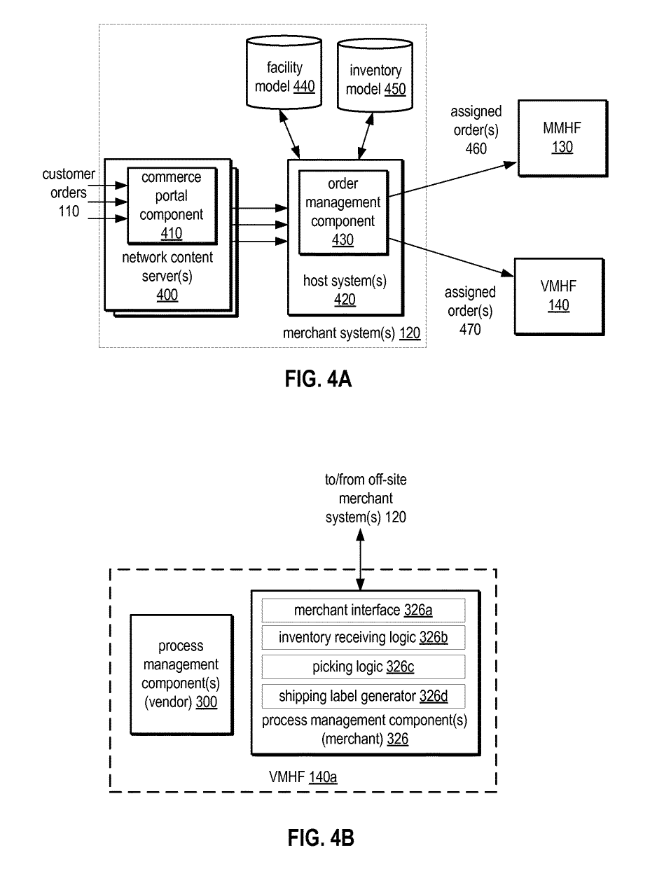

Numerous implications of utilizing the embodiments described herein may also be worthwhile to the vendor as well. For instance, in cases where the vendor typically pays for outbound freight charges to ship inventory items to the merchant, the merchant's receipt of items at the vendor's facility may represent a cost savings to the vendor. In various embodiments, the reduced lead time associated with various embodiments (as described above) may mean that the vendor's items will be made available for sale more quickly relative to traditional techniques. For instance, as soon as the merchant receives inventory items from the vendor at the vendor's facility (or shortly thereafter), the merchant may make such items available for sale through a network-accessible commerce portal, such as that of FIG. 4A described below. In some cases, this may result in a higher volume of the merchant's items be sold through the merchant's sales channels thereby providing the vendor with a competitive advantage (relative to other vendors) and fostering a greater partnership with the merchant.

In various embodiments, some payment arrangements may specify that the vendor is not paid for items provided to the merchant until the merchant actually takes delivery or ownership of such items. By having the merchant take delivery or ownership of the items directly at the vendor's facility (instead of waiting to receive such items later at one of the merchant's facilities), embodiments may provide a mechanism by which the vendor may receive payment more quickly than in traditional schemes.

In traditional item procurement arrangement, there may be circumstances in which the vendor's cost to deliver items to the merchant may be increased. For instance, if the delivery of items is delayed at a merchant facility (e.g., the merchant's receiving operations are experiencing a backlog causing freight carrier delay), the freight carrier may charge the vendor a penalty or fee for such delay. By having the merchant take delivery or ownership of the items directly at the vendor's facility, embodiments may prevent the risk of such penalties or fees being levied on the vendor. By having the merchant take delivery or ownership of the items directly at the vendor's facility, embodiments may also decrease the risk that items may be lost, stolen or damaged en route to the merchant.

FIG. 2 illustrates a logical representation or view of the operation of a merchant materials handling facility of various embodiments of the system and method for managing merchant-performed shipment preparation operations at a vendor facility. In the illustrated embodiments, it should be noted that while this view is provided for merchant materials handling facility 130a, other ones of the merchant's facilities may be configured in a similar fashion. In various embodiments, a fulfillment network including multiple materials handling facilities (each of which may be configured in a manner similar to that of materials handling facility 130a) may be responsible for fulfilling multiple orders, such as orders placed through an electronic commerce (“e-commerce”) portal, such as commerce portal component 110 (described in more detail with respect to FIG. 4A).

In various embodiments, a materials handling facility may include one or more facilities that process, store, and/or distribute units of items including but not limited to warehouses, distribution centers, hubs, fulfillment centers, nodes in a supply chain network, retail establishments, shipping facilities, stock storage facilities, or any other facility configured to process units of items for shipping. For example, this Figure may illustrate an order fulfillment center of a product distributor, according to some embodiments. Multiple customers may submit orders that each specify one or more items from inventory 230 to be shipped to the customer that submitted the order. The customer orders may be provided to an order management component (e.g., order management component 430 of FIG. 4A), which as described in more detail below may assign such orders to a materials handling facility (e.g., a fulfillment center). In the illustrated embodiments (e.g., FIG. 2), the orders assigned to materials handling facility 130a are illustrated as orders 220.

To fulfill the orders 220, one or more items specified in each order may be retrieved, or picked, from inventory 230 (which may also be referred to as stock storage) in the materials handling facility, as indicated at 240. Picked items may be delivered or conveyed, if necessary, to one or more stations in the materials handling facility for sorting 250 into their respective orders, packing 260, and finally shipping 270 to the customers.

In various embodiments, picked items may be delivered to a station where individual units of items are associated with and placed into particular conveyance receptacles, which are then inducted into a conveyance mechanism. The conveyance receptacles may then be routed to particular destinations for the items contained within the receptacles in accordance with the requests (orders) currently being processed, e.g. to sorting stations, under direction of a control system (e.g., process management component 200). A picked, packed and shipped order does not necessarily include all of the items ordered by the customer; an outgoing shipment to a customer may include only a subset of the ordered items available to ship at one time from an inventory storage location.

A materials handling facility may also include a receiving 210 operation for receiving shipments of stock (e.g., units of inventory items) from one or more sources (e.g., vendors) and for moving or “stowing” the received stock into stock storage (e.g., inventory 230). In various embodiments, the receiving 210 operation may also receive and process returned purchased or rented items or orders from customers. At least some of these items are typically returned to inventory 230. The various operations of a materials handling facility may be located in one building or facility, or alternatively may be spread or subdivided across two or more buildings or facilities. In various instances, it should be understood that references to elements, units, items, processes (or anything else) as being located within materials handling facility 130a may easily be extended to encompass elements, units, items, processes (or anything else) proximate to but not physically located within materials handling facility. For example, various elements, units, items, or processes (or anything else) may be implemented outside of the materials handling facility, according to some embodiments.

In various embodiments, shipments of one or more items at shipping 270 may be transferred to one or more shipment carrier network(s). Each shipment carrier's network may include one or more distribution facilities for storing items (e.g., hubs) as well as vehicles for conveying shipments (e.g., trucks) from such distribution facilities and/or materials handling facilities (such as materials handling facility 130a) to various destinations (e.g., customer specified destinations).

FIGS. 3A and 3B illustrate example vendor materials handling facilities according to various embodiments. In the illustrated embodiments, it should be noted that while this view is provided for vendor materials handling facility 140a, other ones of the vendor's facilities may be configured in a similar fashion. As illustrated in FIG. 3A, the illustrated vendor materials handling facility 140a may include vendor controlled operations and merchant controlled operations. In various embodiments, the merchant-controlled operations may be performed in the portion of the facility that the vendor has reserved for the merchant.

In regard to the vendor-controlled operations, the vendor may receive purchase orders illustrated as orders 304. These purchase orders may originate from a variety of different entities, and may in many cases include merchants desiring to sell the vendor's products in a marketplace. In the illustrated embodiment of FIG. 3A, the vendor may actually create items or products directly at facility 140a, as illustrated by product creation 314a. During the product creation 314a, the vendor may receive the illustrated incoming materials (e.g., raw materials, parts, or components for creating other products) and create finished products to be stored as items in inventory 316. At picking 306, the vendor may source items from inventory to fulfill orders 304. If necessary, items may be sorted into respective orders at 308 and prepared for shipment at 310. Shipment preparation 310 may include palletizing, shrink-wrapping or otherwise securing items for shipping 312. Generally, shipments will be sent to other business entities, such as merchants, but there are instances in which the vendor may ship directly to end customers (e.g., retail-level customers).

As described above, in addition to the vendor-controlled operations, vendor materials handling facility 140 may include a portion of the facility reserved for merchant operations, such as the merchant-controlled operations. In various embodiments, the illustrated merchant-controlled operations may constitute all of or a portion of a shipment preparation process performed by the merchant at the vendor's facility. In various embodiments, the shipment preparation process may include procurement operations 320 for submitting purchase orders to the vendor. Purchase orders may be submitted virtually (e.g., as electronic purchase orders) or physically (e.g., as purchase orders in hard copy form). For instance, a hard copy purchase order may be viable if the volume of items to be procured is relatively low. In various embodiments, process management component 326, which may manage the merchant's shipment preparation process, may generate the purchase order that is provided to the vendor. In various embodiments, the items procured may align with customer orders 328 (e.g., orders submitted to the merchant by end customers or “retail” level customers), but this need not be the case in all circumstances. For instance, in some cases, the items that are procured may be items that are forecasted to be needed but not necessarily specified by any existing order 328.

Items received by the merchant may be stored as inventory 324. In some cases, the inventory storage may be more primitive than that found in the merchant's materials handling facilities. For example, in some cases, the merchant's materials handling facilities may include multiple storage systems (e.g., large, numbered shelving units) including numerous bins for housing inventory items. In contrast, inventory 324 may be a more light-weight solution, such as designated areas of floor space. Of course, in some cases, it is possible and contemplated that the merchant-controlled operations may utilize techniques and/or equipment as sophisticated as the merchant's materials handling facilities.

At 330, the merchant (e.g., agents or personnel acting on behalf of the merchant) may pick items from inventory in order to fulfill orders 328. In some cases, process management component 326 may generate pick lists for the agents to utilize when picking items form inventory. In other cases, agents may instead utilize orders 328 to determine which items to pick. If necessary, such as in the case of multi-item shipments, items may also be sorted into respective shipments. For instance, agents may gather items of the same shipment into a grouping in preparation for packing.

At 332, the shipment preparation process may include packing the picked and sorted items into respective shipping containers (e.g., corrugated boxes or other containers suitable for shipping to retail level customers). At shipping 334, the packed shipping containers may be conveyed to the shipping carrier that is tasked with shipping the shipments to retail level customers. By shipping these shipments directly from the vendor's facility, embodiments may realize cost savings for the merchant and/or the vendor for the reasons described above with respect to FIG. 1. Also note that unlike drop-shipping arrangements, the merchant may have an operational presence at the vendor's facility and actually takes ownership of the items received at receiving 322. This too enables certain characteristics, such as the ability for the vendor to be compensated quickly by the merchant, as well as the merchant being able to quickly offer such items for sale in the marketplace. This is described in more detail with respect to FIG. 1 above.

In various embodiments, the illustrated vendor process management component 300 may control or partially control the shipment preparation process performed by the vendor. For instance, at least some of the illustrated operation may be automated under the control of process management component 300. In other cases, some of the operations may be performed by agents (e.g., vendor personnel) either autonomously or in accordance with instructions provided by the process management component.

FIG. 3B illustrates vendor materials handling facility 140a with a slightly different configuration than that shown in FIG. 3A. Relative to FIG. 3A, it should be noted that the description of like-numbered elements of FIG. 3B may be similar to or the same as the corresponding descriptions presented above. In FIG. 3B, instead of the vendor actually creating the items stocked in inventory 326 through a production process (as described above with respect to 314a), the vendor may source items as incoming stock from a manufacturer or other vendor, as illustrated at receiving 314b. In some cases, the vendor may source items as incoming stock from a manufacturer or other vendor, as illustrated at receiving 314b, in addition to creating at least some items or products, as described above with respect to product creation 314a.

In various embodiments, other types of facilities similar to those described above may be utilized. For instance, in some cases, a shipping hub (e.g., a hub of a shipment carrier) may be modified to include the merchant controlled operations described above (e.g., receiving, sorting, packing, etc.) as well as the merchant-controlled process management component 326 for controlling the shipment preparation process and other merchant-controlled operations. In general, any facility in which the merchant's operations and process management component 326 may be added may be utilized in various embodiments.

FIG. 4A illustrates the merchant systems that the merchant may utilize for receiving orders and assigning respective orders to the facilities of the merchant's facility network. In the illustrated embodiment of FIG. 4A, customers may utilize customer systems (e.g., personal computers or other electronic devices) in order to browse an electronic product catalog offered by the merchant. For instance, merchant systems 120 may include one or more network content server(s) 400 configured to implement commerce portal component 410. In various embodiments, commerce portal component 410 may be the portion of network content server(s) 400 that is responsible for providing commerce portal content (e.g., product detail web pages, checkout and shopping cart web pages, etc.) to customers. For instance, commerce portal content may include product detail pages for browsing various items and information for purchasing items (e.g., data representing an electronic shopping cart or check-out process). In various embodiments, product detail pages may be generated by commerce portal component 410 based on information from a product catalog data store (not illustrated), which may include product details (e.g., prices, images, descriptions, customer reviews, etc.) for items offered by the merchant. In various embodiments, customers may utilize a web browser to submit an order for one or more items to the merchant. For instance, the customer may utilize a browser to add the one or more items to an electronic shopping cart and to purchase the item(s) in the shopping cart. The merchant may store information about the customer (e.g., contact information, shipping information, payment information, etc.) and/or order information (e.g., items in the order, total cost of order, shipping options, etc.) in a customer/order data store (not illustrated).

In various embodiments, orders submitted by customers may be provided to an order management component, such as order management component 430 of host system 420. In various embodiments, order management component may be configured to assign fulfillment of a customer order to one or more merchant materials handling facilities and/or the merchant operations of a vendor's materials handling facility, such as those described above. In various embodiments, the orders assigned to facilities may be full or partial orders. For instance, in some cases entire orders may be assigned to the same facility. In other cases, different portions of the same order may be assigned to different facilities, in which case the same order may be split across multiple different shipments.

Order management component 430 may utilize information from facility model 440 and inventory model 450 to determine to which facility a given order is to be assigned. In various embodiments, both of such models may be created, updated, and/or maintained by the order management component 430 or some other component of the merchant's systems. In the illustrated embodiment, inventory model 450 may include information or data specifying the inventory levels (e.g., types of inventory, such as identified by a stock keeping unit or number, as well as the quantities of such inventory) at various merchant materials handling facilities as well as the vendor materials handling facilities. Note that for the purposes of the merchant's order assignment, the merchant may in most cases evaluate the merchant-owned inventory at the vendor facilities (whereas the vendor-owned inventory may not be considered by the merchant within this context). In one example for an order include one or more items, the order management component may determine a list of candidate facilities to which the order may be sent as being a list of facilities that each have sufficient inventory to fulfill the specific one or more items of the order. In cases where multiple candidate facilities are identified by order management component 430, the order management component 430 may select the facility that is expected to cost the least to fulfill the order (relative to the other candidate facilities). In various embodiments, the cost criteria and cost information for different facilities may be stored in facility model 440, in some embodiments. In various embodiments, order management component 430 may take the order processing load of each facility into account when performing order assignment. For instance, in the example above, if the least expensive materials handling facility currently has an order workload above a threshold quantity of orders, the order management component 430 may assign the order to the next least-expensive facility. In various embodiments, it is possible and contemplated to assign orders to facilities based on other types of criteria.

In the illustrated embodiment, order management component 430 may assign orders to any of merchant materials handling facilities 130, as illustrated as assigned orders 460, as well as to any of the merchant-controlled portions of vendor materials handling facilities 140, as illustrated as assigned orders 470. In some but not necessarily all cases, vendor facilities and merchant facilities may be treated in a similar manner for purposes of order assignment.

In some cases, the merchant system may also include a planning component (not illustrated) configured to automatically determine where and/or when merchant operations and systems should be deployed to vendor facilities (e.g., in order to create a vendor material handling facility similar to FIGS. 3A-3B). For instance, such a planning component may be configured to identify vendors that typically supply heavy objects, bulky objects, or other objects that have high transportation or handling costs. For example, some vendors may typically provide items that are not cost-efficient to transport to the merchant's facilities. In these cases, the planning component may identify these vendors (and their facilities) and generate a suggestion to establish merchant operations and system at one or more of the vendor's facilities (e.g., similar to FIGS. 3A-3B). In other cases, customer population changes in various regions may give rise to new demand that could benefit form a vendor materials handling facility. The planning component may be configured to analyze regional data to identify areas that may benefit form a vendor materials handling facility. In various embodiments, reports generated by a planning component may be utilized by management to make decisions, such as where and when to establish operations and systems at a vendor's facility (e.g., similar to FIGS. 3A-3B).

FIG. 4B illustrates an example of the systems and components present at a given one of the vendor materials handling facilities. The illustrated embodiment illustrates vendor materials handling facility 140a, although the description provided here may also apply to other one of vendor materials handling facilities 140. As described above, process management component 300 may control or partially control the shipment preparation process performed by the vendor. For instance, at least some of the vendor's shipment preparation operations may be automated under the control of process management component 300. In other cases, some of the operations may be performed by agents (e.g., vendor personnel) either autonomously or in accordance with instructions provided by process management component 300.

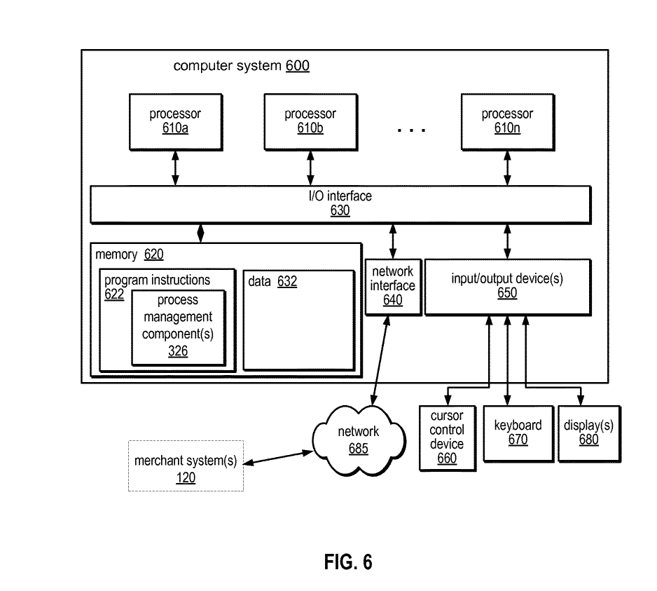

The merchant's operation at the vendor facility may in various embodiments be controlled by the illustrated process management component(s) 326. In various embodiments, process management component(s) may be implemented as one or more computer systems (such as the computer system 600 of FIG. 6) and the illustrated elements 326a-d may be implemented as program instructions executing on such computer systems.

In various embodiments, merchant interface 326a may be configured to communicate with off-site merchant systems 120. For instance, merchant interface 326 may receive assigned orders 470 from order management component 430. In various embodiments, process management components 326 may include inventory receiving logic 326b. Logic 326b may be configured to record all items procured by the merchant at the vendor facility (e.g., at receiving 322) and send such information to the off-site merchant systems 120. In various embodiments, merchant systems 120 may utilize such information to update inventory model 450.

In various embodiments, picking logic 326 may drive the merchant's sorting and picking process 330. For example, in some cases, picking logic 326 may be configured to generate one or more pick lists for orders that are to be shipped from the vendor's facility. In some cases, the pick list may also specify how items should be partitioned or sorted into respective shipments. For instance, in cases where multiple item shipments are prepared by the merchant's shipping preparation process, the pick list may specify how agents are to group items for placement into a respective shipping container.

In various embodiments, ship label generator 326d may be configured to generate the appropriate shipping labels to be affixed to packages prepared by the merchant at the vendor's facility. These shipping labels may be affixed to respective packages during the shipping process 334 described above. Shipped packages may be recorded by merchant interface 326a, and such information may be forwarded to merchant systems 120 for record keeping purposes (e.g., to keep track of the order state and metadata, such as package tracking information).

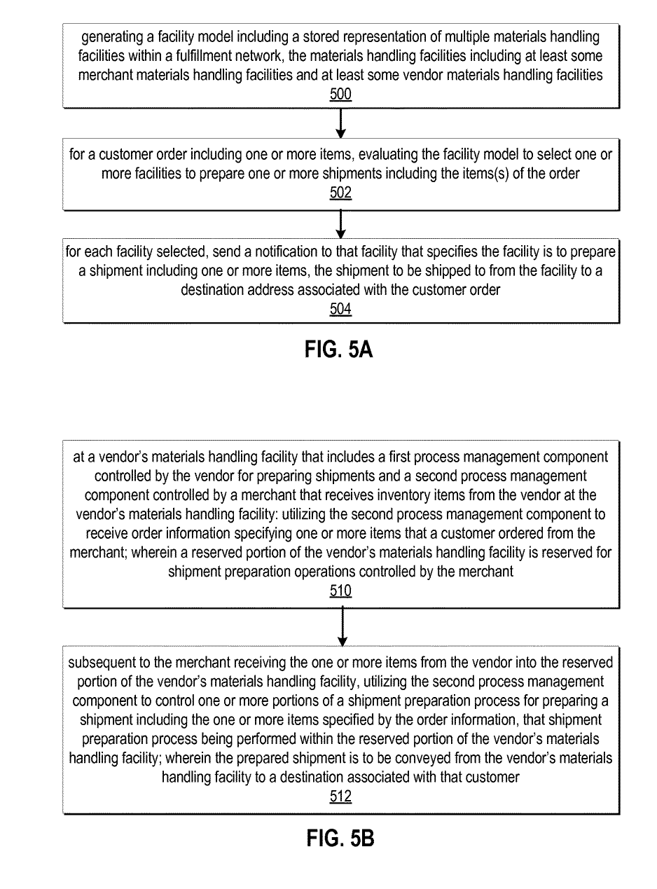

Embodiments may include various methods, example of which are illustrated in FIGS. 5A and 5B. In some embodiments, these methods may be performed by one or more computers, such as computer 600 of FIG. 6. FIG. 5A illustrates a flowchart of an example method for generating and evaluating a facility model in order to assign shipments of items to materials handling facilities within a fulfillment network. In various embodiments, order management component 430 (or another component or system operated by the merchant entity) may perform the method of FIG. 5A. As illustrated at block 500, the method may include generating a facility model including a stored representation of a multiple materials handling facilities within a fulfillment network. Furthermore, the materials handling facilities may include at least some merchant materials handling facilities (e.g., similar to merchant materials handling facility 130a) and at least some vendor materials handling facilities (e.g., similar to vendor materials handling facility 140a). In this way, the merchant's view of the fulfillment network includes not only the merchant's own facilities, but also the extra capacity provided by the vendor materials handling facilities that include merchant controlled operations and systems (e.g., as described above with respect to FIGS. 3A-3B). In various embodiments, the facility model may include characteristics about each facility, such as geographic location (e.g., address, zip code), cost information (e.g., average costs associated with preparing shipments at that facility), current processing capacity, current inventory, and any other characteristic associated with shipment preparation at the facility.

As illustrated at block 502, the method may include, for a customer order including one or more items, evaluating the facility model to select one or more facilities to prepare one or more shipments including the one or more items. In various embodiments, this may include evaluating the aforesaid facility characteristics stored in the model. For example, evaluating the model may include determining which facilities can provide the ordered items to the customer by the requested delivery date and, of those, which can provide the items at the lowest cost. In other cases, other criteria associated with fulfilling the order may be utilized. Generally, meeting the customer's expectations (e.g., providing the items by the appropriate delivery date) and minimizing costs (e.g., fulfillment costs, shipping costs, labor costs, etc.) are utilized as criteria in many embodiments.

As illustrated at block 504, the method may include, for each facility selected, send a notification to that facility that specifies the facility is to prepare a shipment including one or more items, the shipment to be shipped to from the facility to a destination address associated with the customer order. For example, in some embodiments, a given customer order may be divided into multiple shipments, which may be fulfilled at the same facility or at different facilities. The method may include, for each one of those shipments, sending a notification to the facility that is to prepare the shipment. The notification may specify the items of the shipment as well as information specifying when the shipment is expected to be shipped and/or delivered.

In various embodiments, by assigning shipments to vendor materials handling facilities equipped with merchant controlled operations (see e.g., FIGS. 3A-3B), embodiments may leverage additional capacity to meet peak customer demand (e.g., a seasonal increase in orders). In some cases, utilizing the types of vendor materials handling facilities described herein to augment the existing merchant materials handling facilities may enable the merchant to quickly meet demand because establishing merchant operations and systems at a vendor facility may have a shorter lead time than constructing an entire new facility. Furthermore, in many case it may be more cost efficient to utilize the vendor materials handling facilities because merchant operations at a vendor materials handling facility can be removed during periods of low demand. This contrasts with new merchant facilities as it is typically not cost effective to build a new merchant facility only to have the facility fall idle during periods of low demand.

FIG. 5B illustrates a flowchart of an example method for managing merchant-performed shipment preparation operations at a vendor facility. In the illustrated embodiment, the portion of the method corresponding to block 510 may be performed at a vendor's materials handling facility (e.g., vendor materials handling facility 140a described above) that includes a first process management component (e.g., process management component 300 described above) controlled by the vendor for preparing shipments. This vendor's materials handling facility may also include a second process management component (e.g., process management component 326 described above) controlled by a merchant that receives inventory items from the vendor at the vendor's materials handling facility. Furthermore, block 510 may include utilizing the second process management component to receive order information (e.g., assigned orders 470 described above) specifying one or more items that a customer ordered from the merchant. In various embodiments, a reserved portion of the vendor's materials handling facility is reserved for shipment preparation operations controlled by the merchant (e.g., such as described above with respect to FIGS. 3A-3B).

As illustrated by block 512, the method may also include, subsequent to the merchant receiving the one or more items from the vendor into the reserved portion of the vendor's materials handling facility (e.g., receiving 322 described above), utilizing the second process management component to control one or more portions of a shipment preparation process for preparing a shipment including the one or more items specified by the order information. In various embodiments, the shipment preparation process may be performed within the reserved portion of the vendor's materials handling facility. In various embodiments, the prepared shipment may be conveyed from the vendor's materials handling facility to a destination associated with that customer.

Various embodiments of the system and method for managing merchant-performed shipment preparation operations at a vendor facility, as described herein, may be executed on one or more computer systems, which may interact with various other devices. Note that any component, action, or functionality described above with respect to FIGS. 1-5 may be implemented via one or more computer systems configured as computer system 600 of FIG. 6, according to various embodiments. For instance, any of the systems or components described above with respect to FIG. 3A-FIG. 4B may be implemented by a computer system similar to computer system 600, in various embodiments. In the illustrated embodiment, computer system 600 includes one or more processors 610 coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In some cases, it is contemplated that embodiments may be implemented using a single instance of computer system 600, while in other embodiments multiple such systems, or multiple nodes making up computer system 600, may be configured to host different portions or instances of embodiments. For example, in one embodiment some elements may be implemented via one or more nodes of computer system 600 that are distinct from those nodes implementing other elements.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs), such as the x86, PowerPC, SPARC, or MIPS ISAs, or any other suitable ISA. In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions 622 implementing process management component(s) 326 are shown stored within memory. Additionally, data 632 of memory 620 may store any of the information or data structures described above. In some embodiments, program instructions and/or data may be received, sent or stored upon different types of computer-accessible media or on similar media separate from system memory 620 or computer system 600. While computer system 600 is described as implementing the functionality of process management component(s) 326, any of the components or systems illustrated above may be implemented via such a computer system.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices (e.g., merchant systems 120) attached to a network 685 or between nodes of computer system 600. Network 685 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

As shown in FIG. 6, memory 620 may include program instructions 622 configured to implement any element or action described above. In one embodiment, the program instructions may implement the methods described above, such as the method illustrated by FIG. 5B. In other embodiments, different elements and data may be included. Note that data 632 may include any data or information described above.

Those skilled in the art will appreciate that computer system 600 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above.

In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of embodiments as defined in the claims that follow.

1. A method, comprising:
receiving by a merchant, into a reserved merchant area of a vendor's materials handling facility reserved for shipment preparation operations controlled by the merchant, items from the vendor, wherein the reserved merchant area is physically separate from the remainder of the facility controlled by the vendor;
performing, by one or more computing devices:
generating an inventory model that specifies inventory levels at both:
one or more merchant materials handling facilities, and
the vendor's materials handling facility;
for a customer order including one or more items, evaluating the model to select a facility to prepare one or more items for shipment;
transmitting, over a network, a notification to the facility instructing the facility to prepare the one or more items for shipment;
executing a merchant process management component controlled by a merchant, said executing comprising executing the merchant process management component at a vendor's materials handling facility, wherein the vendor's materials handling facility includes a vendor process management component controlled by the vendor for preparing shipments, wherein a reserved portion of the vendor's materials handling facility is reserved for shipment preparation operations controlled by the merchant;
recording, by the merchant process management component, items received into the reserved portion of the vendor's materials handling facility by the merchant from the vendor at the vendor's materials handling facility;
receiving, from the order management component by the merchant process management component, order information specifying one or more items that a customer ordered from the merchant; and
subsequent to the merchant receiving said one or more items from the vendor into the reserved portion of the vendor's materials handling facility,
controlling, by the merchant process management component implemented on one or more computing devices, one or more portions of a shipment preparation process performed in the reserved merchant area of the vendor's materials handling facility, the shipment preparation process comprising preparing a shipment including the one or more items specified by the order information, said controlling comprising:
instructing the one or more portions of the shipment preparation process being performed within the reserved portion of the vendor's materials handling facility, the one or more portions of the shipment preparation process comprising preparation, in the reserved merchant area of the vendor's materials handling facility, of the one or more items for shipment;
generating, by a merchant's shipping label generator in the reserved merchant area of the vendor's materials handling facility, in response to an instruction from the merchant process management component, a shipping label to be affixed to a shipping container for the one or more items; and
instructing conveyance of the prepared shipment from the reserved merchant area to be shipped from the vendor's materials handling facility to a destination indicated by the shipping label generated in the reserved merchant area of the vendor's materials handling facility.

2. The computer-implemented method of claim 1, wherein ownership of said one or more items is transferred from the vendor to the merchant while said one or more items are located within the vendor's materials handling facility.

3. The computer-implemented method of claim 1, wherein the merchant operates one or more materials handling facilities separate from the vendor's materials handling facility, wherein said one or more items are shipped from the vendor's materials handling facility to said destination associated with the customer without said one or more items being conveyed to the merchant's one or more materials handling facilities.

4. The computer-implemented method of claim 1, wherein the method comprises utilizing the merchant process management component to generate a pick list that specifies said one or more items are to be picked from merchant-owned inventory at the vendor's materials handling facility.

5. The computer-implemented method of claim 1, wherein the method comprises utilizing the merchant process management component to generate a shipping label to be affixed to a shipping container in which said one or more items are to be packed.

6. The computer-implemented method of claim 1, wherein the method comprises, prior to receiving said one or more items from the vendor, providing the vendor with a purchase order specifying said one or more items.

7. The computer-implemented method of claim 6, wherein the method comprises determining the items to be included in the purchase order based on an order assigned to the materials handling facility by a remote order management component controlled by the merchant.

8. The computer-implemented method of claim 1, wherein the method comprises, in response to receiving said one or more items from the vendor into the reserved portion of the vendor's materials handling facility, sending a notification that indicates the items have been received into the reserved portion to a remote order management component controlled by the merchant for updating a remote inventory model of the items in the reserved portion of the vendor's materials handling facility.

9. The computer-implemented method of claim 1, wherein the method comprises, responsive to receiving said one or more items in the reserved portion of the vendor's materials handling facility, providing the vendor with payment for said one or more items.

10. A system, comprising:
a reserved merchant area of a vendor's materials handling facility reserved for shipment preparation operations controlled by a merchant, wherein the merchant receives items from the vendor into the reserved merchant area at the vendor's materials handling facility, and wherein the reserved merchant area is physically separate from the remainder of the facility controlled by the vendor;
a memory; and
one or more processors coupled to the memory, wherein the memory comprises program instructions executable by the one or more processors to implement:
an order management component configured to:
generate an inventory model that specifies inventory levels at both:
one or more merchant materials handling facilities, and
the vendor's materials handling facility;
for a customer order including one or more items, evaluate the model to select a facility to prepare one or more items for shipment; and
transmit, over a network, a notification to the facility instructing the facility to prepare the one or more items for shipment; and
a merchant process management component at a vendor's materials handling facility that also includes a vendor process management component controlled by the vendor for preparing shipments, the merchant process management component controlled by a merchant, wherein a reserved portion of the vendor's materials handling facility is reserved for shipment preparation operations controlled by the merchant, wherein the merchant receives items from the vendor into the reserved portion at the vendor's materials handling facility, the merchant process management component configured to:
record items received into the reserved portion of the vendor's materials handling facility by the merchant from the vendor at the vendor's materials handling facility;
receive, from the order management component, order information specifying the one or more items that a customer ordered from the merchant; and
subsequent to the merchant receiving said one or more items from the vendor into the reserved portion of the vendor's materials handling facility:
control one or more portions of a shipment preparation process performed in the reserved merchant area of the vendor's materials handling facility, the shipment preparation process comprising preparation of a shipment including the one or more items specified by the order information, said control comprising:
instruct the one or more portions of the shipment preparation process to be performed within the reserved portion of the vendor's materials handling facility, the one or more portions of the shipment preparation process comprising preparation, in the physically separate reserved merchant area of the vendor's materials handling facility of the one or more items for shipment; and
a merchant's shipping label generator in the reserved merchant area of the vendor's materials handling facility, the label generator configured to generate, in response to an instruction from the merchant process management component, a shipping label to be affixed to a shipping container for the one or more items;
wherein the merchant process management component is further configured to:
instruct conveyance of the prepared shipment from the reserved merchant area to be shipped from the vendor's materials handling facility to a destination indicated by the shipping label generated in the reserved merchant area of the vendor's materials handling facility.

11. The system of claim 10, wherein ownership of said one or more items is transferred from the vendor to the merchant while said one or more items are located within the vendor's materials handling facility.

12. The system of claim 10, wherein the merchant operates one or more materials handling facilities separate from the vendor's materials handling facility, wherein said one or more items are shipped from the vendor's materials handling facility to said destination associated with the customer without said one or more items being conveyed to the merchant's one or more materials handling facilities.

13. The system of claim 10, wherein the merchant process management component is configured to generate a pick list that specifies said one or more items are to be picked from merchant-owned inventory at the vendor's materials handling facility.

14. The system of claim 10, wherein the merchant process management component is configured to generate a shipping label to be affixed to a shipping container in which said one or more items are to be packed.

15. The system of claim 10, wherein the merchant process management component is configured to, prior to receiving said one or more items from the vendor, provide the vendor with a purchase order specifying said one or more items.

16. The system of claim 15, wherein the merchant process management component is configured to determine the items to be included in the purchase order based on an order assigned to the materials handling facility by a remote order management component controlled by the merchant.

17. The system of claim 10, wherein the merchant process management component is configured to, in response to receiving said one or more items from the vendor into the reserved portion of the vendor's materials handling facility, send a notification that indicates the items have been received into the reserved portion to a remote order management component controlled by the merchant for updating a remote inventory model of the items in the reserved portion of the vendor's materials handling facility.

18.-25. (canceled)
